(19) United States
(12) Patent Application Publication
(10) Pub. No.: US 2026/0278908 A1
(43) Pub. Date: Sep. 17, 2026

(54) DATA PROCESSING APPARATUS, METHOD AND COMPUTER PROGRAM FOR GENERATING ONE OR MORE IMAGES OF A VIRTUAL ENVIRONMENT

(71) Applicant: Sony Interactive Entertainment Inc., Tokyo (JP)

(72) Inventors: Alex Dixon, London (GB); Alexis Lechat, London (GB)

(21) Appl. No.: 19/564,918

(22) Filed: Mar. 12, 2026

(30) Foreign Application Priority Data
Mar. 12, 2025 (GB) 2503607.0

(51) Int. Cl. G06T 15/00

(52) U.S. Cl. CPC G06T 15/00

(57) ABSTRACT

A data processing apparatus for generating one or more images of a virtual environment includes: a rendering processor configured to perform a first rendering task of a set of rendering tasks for rendering the images; a communication processor configured to request, from a remote computing device, data generated by performing a second rendering task for rendering the images; an output image processor configured to generate the images for display at least in part based on data generated by performing the first rendering task and data generated by performing the second rendering task; and an allocation processor configured to allocate a task as the first rendering task or the second rendering task based on available processing resources of the data processing apparatus and an available communication bandwidth between the communication processor and the remote computing device.

### CROSS-REFERENCE TO RELATED APPLICATIONS

This application claims priority to United Kingdom Application No. 2503607.0, filed on Mar. 12, 2025, the contents of which are incorporated herein by reference.

### BACKGROUND

### Field of the Disclosure

The present disclosure relates to a data processing apparatus, method and computer program for generating one or more images of a virtual environment.

### Description of the Related Art

The “background” description provided herein is for the purpose of generally presenting the context of the disclosure. Work of the presently named inventors, to the extent it is described in the background section, as well as aspects of the description which may not otherwise qualify as prior art at the time of filing, are neither expressly or impliedly admitted as prior art against the present invention.

The speed and realism with which a scene can be rendered is a key consideration in the field of computer graphics processing. Graphics processing operations are performed by a processing unit (e.g. a GPU and/or a CPU) as part of an execution of an application such as a videogame. Graphics processing operations typically comprise processing of model data or other predefined graphics data for graphical features in accordance with a graphics processing pipeline to generate image data for an image frame.

As virtual environments (such as videogames) become more complex and feature-rich, conventional videogame rendering systems (such as graphics engines, graphics drivers, and/or graphics cards) often struggle to render images of a sufficient resolution and/or at a sufficient frame rate. The processing power of such systems may be scaled (e.g. additional GPUs may be provided) to meet this increased processing load-however, for most users, this is prohibitively expensive. As such, there is a need to improve graphical rendering efficiency.

Indeed, when a videogame rendering system struggles to render images, this may increase the rendering latency (that is, the time from when the frame is supposed to be rendered to the time at which the frame has been completed rendered for display). In some situations, high latency can make it very difficult for a user to use or fully enjoy a virtual environment.

It is an aim of the present disclosure to address these issues.

### SUMMARY

A brief summary about the present disclosure is provided hereinafter to provide a basic understanding related to certain aspects of the present disclosure.

Embodiments of the present disclosure are defined by the independent claims. Further aspects of the disclosure are defined by the dependent claims.

In accordance with embodiments of the disclosure, efficient allocation of rendering tasks can be made in a hybrid rendering environment. Furthermore, latency when rendering a virtual environment—such as a videogame—can be reduced, leading to a smoother and more responsive gaming experience.

The present disclosure is not particularly limited to these advantageous technical effects. Other technical effects will become apparent for the skilled person when reading the disclosure.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 illustrates an example apparatus in accordance with embodiments of the disclosure;

FIG. 2 illustrates an entertainment system in accordance with embodiments of the disclosure;

FIG. 3 illustrates an example data processing apparatus in accordance with embodiments of the disclosure;

FIG. 4 illustrates an example system in accordance with embodiments of the disclosure;

FIG. 5 illustrates an example of task allocation in accordance with embodiments of the disclosure.

FIG. 6 illustrates an example method in accordance with embodiments of the disclosure.

### DESCRIPTION OF THE EMBODIMENTS

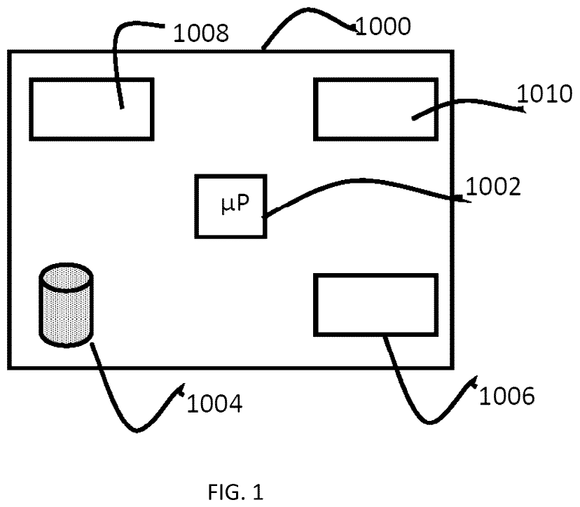

Referring to FIG. 1, an example apparatus 1000 (an example of an information processing device) according to embodiments of the disclosure is shown. Typically, an apparatus 1000 according to embodiments of the disclosure is a computer device such as a personal computer, an entertainment system or videogame console, or a terminal connected to a server. Indeed, in embodiments, the apparatus may also be a server. The apparatus 1000 is controlled using a microprocessor or other processing circuitry 1002. In some examples, the apparatus 1000 may be a portable computing device such as a mobile phone, laptop computer or tablet-computing device.

The processing circuitry 1002 may be a microprocessor carrying out computer instructions or may be an Application Specific Integrated Circuit. The computer instructions are stored on storage medium 1004 which maybe a magnetically readable medium, optically readable medium or solid state type circuitry. The storage medium 1004 may be integrated into the apparatus 1000 or may be separate to the apparatus 1000 and connected thereto using either a wired or wireless connection. The computer instructions may be embodied as computer software that contains computer readable code which, when loaded onto the processor circuitry 1002, configures the processor circuitry 1002 to perform a method according to embodiments of the disclosure.

Additionally, an optional user input device 1006 is shown connected to the processing circuitry 1002. The user input device 1006 may be a touch screen or may be a mouse or stylist type input device. The user input device 1006 may also be a keyboard, controller, or any combination of these devices. In some examples, the user input device 1006 may be a microphone or other device. The user to may then provide input via sounds or speech.

A network connection 1008 may optionally be coupled to the processor circuitry 1002. The network connection 1008 may be a connection to a Local Area Network or a Wide Area Network such as the Internet or a Virtual Private Network or the like. The network connection 1008 may be connected to a server allowing the processor circuitry 1002 to communicate with another apparatus in order to obtain or provide relevant data. The network connection 1002 may be behind a firewall or some other form of network security.

Additionally, shown coupled to the processing circuitry 1002, is a display device 1010. The display device 1010, although shown integrated into the apparatus 1000, may additionally be separate to the apparatus 1000 and may be a monitor or some kind of device allowing the user to visualize the operation of the system (e.g. a display screen or a head mounted display). In addition, the display device 1010 may be a printer, projector or some other device allowing relevant information generated by the apparatus 1000 to be viewed by the user or by a third party.

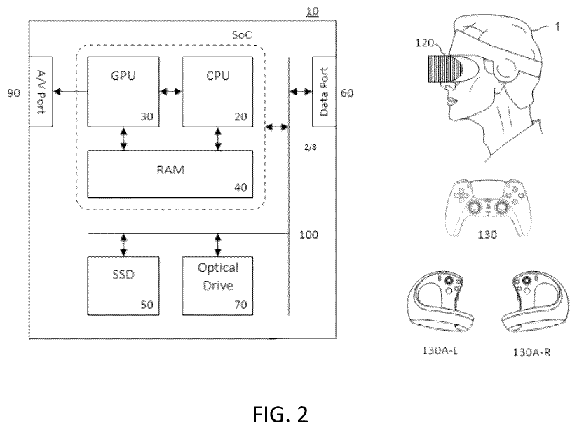

Consider, now, FIG. 2 of the present disclosure. FIG. 2 illustrates an example of an entertainment system.

The entertainment system 10 is a computer or console.

The entertainment system 10 includes a central processor or CPU 20. The entertainment system also includes a graphical processing unit or GPU 30, and RAM 40. Two or more of the CPU, GPU, and RAM may be integrated as a system on a chip (SoC).

Further storage may be provided by a disk 50, either as an external or internal hard drive, or as an external solid state drive, or an internal solid state drive.

The entertainment device may transmit or receive data via one or more data ports 60, such as a USB port, Ethernet® port, Wi-Fi® port, Bluetooth® port or similar, as appropriate. It may also optionally receive data via an optical drive 70.

Audio/visual outputs from the entertainment device are typically provided through one or more A/V ports 90 or one or more of the data ports 60.

Where components are not integrated, they may be connected as appropriate either by a dedicated data link or via a bus 100.

An example of a device for displaying images output by the entertainment system is a head mounted display ‘HMD’ 120, worn by a user 1.

Interaction with the system is typically provided using one or more handheld controllers 130, and/or one or more VR controllers (130A-L, R) in the case of the HMD.

As explained in the Background, the speed and realism with which a scene can be rendered is a key consideration in the field of computer graphics processing. Graphics processing operations are performed by a processing unit (e.g. a GPU and/or a CPU) as part of an execution of an application such as a videogame. Graphics processing operations typically includes processing of model data or other predefined graphics data for graphical features in accordance with a graphics processing pipeline to generate image data for an image frame.

As virtual environments (such as videogames) become more complex and feature-rich, conventional videogame rendering systems (such as graphics engines, graphics drivers, and/or graphics cards) often struggle to render images of a sufficient resolution and/or at a sufficient frame rate. The processing power of such systems may be scaled (e.g. additional GPUs may be provided) to meet this increased processing load—however, for most users, this is prohibitively expensive. As such, there is a need to improve graphical rendering efficiency.

Indeed, when a videogame rendering system struggles to render images, this may increase the rendering latency (that is, the time from when the frame is supposed to be rendered to the time at which the frame has been completed rendered for display). In some situations, high latency can make it very difficult for a user to use or fully enjoy a virtual environment.

Accordingly, a data processing apparatus, method and computer program are provided in accordance with embodiments of the disclosure.

### Data Processing Apparatus

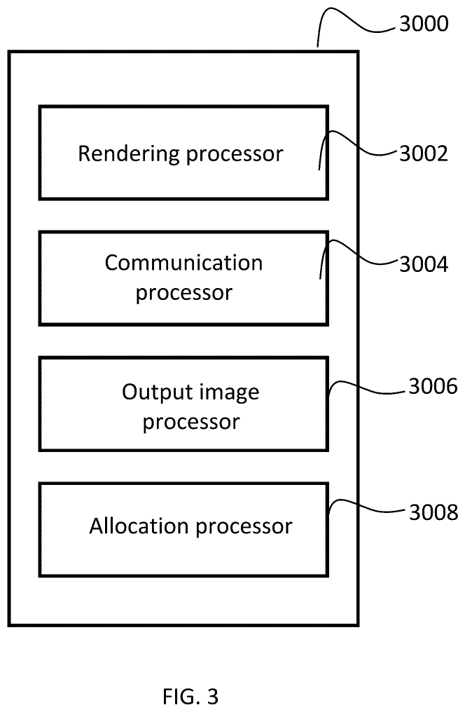

Consider, now, FIG. 3 of the present disclosure. FIG. 3 of the present disclosure illustrates an example data processing apparatus in accordance with embodiments of the disclosure.

The example data processing apparatus 3000 illustrated in FIG. 3 includes a rendering processor 3002, a communication processor 3004, an output image processor 3006 and an allocation processor 3008.

The rendering processor 3002 is configured to perform a first rendering task of a set of rendering tasks for rendering the one or more images.

The communication processor 3004 is configured to request, from a remote computing device, data generated by performing a second rendering task of a set of rendering tasks for rendering the one or more images.

The output image processor 3006 is configured to generate the one or more images for display at least in part based on data generated by performing the first rendering task and data generated by performing the second rendering task.

The allocation processor 3008 is configured to allocate a task of the set of rendering tasks as the first rendering task or the second rendering task based on available processing resources of the data processing apparatus and an available communication bandwidth between the communication processor and the remote computing device.

In this way, the data processing apparatus 3000 is configured to perform an allocation of rendering tasks between the rendering processor and the remote computing device, which improves efficiency and reduces latency of rendering. In particular, it will be appreciated that, in a hybrid rendering environment (where rendering is shared between a local data processing apparatus and a remote computational device) there are a number of different potential sources of latency.

The first of these is latency arising from the processing limitation of the local data processing apparatus. That is, often, the local data processing apparatus may have a limited, finite, set of computational resources. In particular, the computational resources of the local data processing apparatus may be considerably less than the computational resources which are available to a remote processing device. Accordingly, if too much demand is placed upon the local data processing apparatus, there may be latency as the local data processing apparatus struggles to render images of a sufficient resolution and/or at a sufficient frame rate.

On the other hand, the remote computing device often has a much high quantity of computational resources available for processing (being part, for example, of a large server or the like). However, in order for the remote computing device to perform processing to assist the local data processing device, the local data processing device requests certain data from the remote computing device. The process of sending and receiving data to and from the remote computing device uses a communication network between the local data processing apparatus and the remote computing device. Therefore, depending on the amount of data to be sent and the state of the network, the use of the remote computing device can also introduce latency (with the latency arising from the time taken to perform communication of the data over the network). In examples, the data sent to the remote computing device may include information concerning the rendering task to be performed and information concerning the virtual environment which is to be rendered. In examples, the information sent to the remote computing device may also include the result of any rendering which has been performed by the data processing apparatus (e.g. if the result of one part of the rendering pipeline is to be used as a basis for the performance of the next part of the rendering pipeline). However, the data received from the remote computing device may include a result of the rendering which has been performed by that remote computing device (e.g. any data which can be used, by the output image processor, to generate the one or more images for display (e.g. by compiling the result of the rendering which has been performed)).

In accordance with embodiments of the disclosure, the output image processor 3006 may be configured to combine the rendering which has been performed by the rendering processor of the data processing apparatus (i.e. the data generated by performing the first rendering task) and the rendering which has been performed by the remote computing device (i.e. the data generated by performing the second rendering task) in order to produce the output image for display. The way in which the rendering performed by the data processing apparatus and the remote computing device is combined depends on which task (or tasks) have been allocated to each of the data processing apparatus and the remote computing device. For example, in cases where the different rendering tasks have been performed, for the same image region, by the data processing apparatus and the remote computing device, the output image processor may combine the results of these different rendering tasks in order to produce the output image for display.

Accordingly, embodiments of the disclosure provide an efficiency way of allocating rendering tasks between the rendering processor of the data processing apparatus and the remote computational device. That is, the allocation processor 3008 of the data processing apparatus is configured to allocate a task of the set of rendering tasks which should be performed as either a first rendering task (to be performed by the rendering processor of the data processing apparatus) or a second rendering task (to be performed by the remote computing device) based on available processing resources of the data processing apparatus and an available communication bandwidth between the communication processor 3004 (of the data processing apparatus) and the remote computing device. In this way, the allocation of rendering tasks can be adapted to minimise latency by selecting a most appropriate device (from amongst the data processing apparatus and the remote computing device) for performing a given rendering task.

In examples, the allocation processor may be configured to use a machine learning model for allocation of a task of the set of rendering tasks as the first rendering task or the second rendering task. The machine learning model may include a deep learning model, for example. This will be discussed in more detail later.

In examples, the allocation processor may be configured to apply one or more heuristics for allocation of the task of the set of rendering tasks as the first rendering task or the second rendering task. The heuristics may include one or more predefined rules which can be used by the allocation processor for allocation of a rendering task as a first rendering task (to be performed by the data processing apparatus) or a second rendering task (to be performed by the remote computing device). This will also be explained in more detail later.

In some examples, the allocation processor may be configured to prioritise allocation of a task of the set of rendering tasks as the first rendering task within a performance metric of the generation of the one or more images of the virtual environment. That is, the use of the data processing apparatus for rendering tasks may be prioritised, provided that the data processing apparatus is able to perform the rendering task with a certain performance metric (e.g. without increasing latency above a threshold value). Prioritisation of the local data processing apparatus in this manner may be performed as the use of the local data processing apparatus for performing the rendering, where appropriate, automatically reduces the network communication resources (as no transfer of data between the data processing apparatus and the remote computing device then needs to occur).

In some examples, such as when the data processing apparatus 3000 is a portable or mobile device, the data processing apparatus 3000 may be powered by an electrical storage device (such as a battery) included within the data processing apparatus. The maximum capacity of the electrical storage device may vary depending on the type of portable or mobile device. However, it will be appreciated that the remaining capacity of the electrical storage device will be depleted each time an energy consuming rendering task is performed by the data processing apparatus 3000. Therefore, in some examples, the allocation processor may be further configured to perform allocation of a task as a first rendering task (to be performed by the data processing apparatus) or a second rendering task (to be performed by the remote computing device) depending on a status of the electrical storage device and/or an electrical (i.e. power/energy) cost of that task. In examples, the status of the electrical storage device may include a maximum capacity of the electrical storage device, a remaining capacity of the electrical storage device, or the like. In examples, the electrical cost of that task to be allocated may include the amount of electrical energy which will be consumed by performing that rendering task on the data processing apparatus. In examples, the allocation processor may, therefore, allocate a task to the remote computing device (i.e. as a second rendering task) if the electrical cost of that task is high compared to the remaining amount of electrical energy in the electrical storage device, and/or if the electrical cost is above a predetermined threshold. Moreover, in examples, the allocation processor may always attempt to allocate energy intensive rendering tasks to the remote computing device, in order to preserve the remaining capacity of the electrical storage device.

Furthermore, in some examples, the data processing apparatus 3000 may have certain limitations on the type of rendering task it can perform. For example, a data processing apparatus may have a list of capabilities, which indicate that the data processing apparatus cannot perform a certain type of rendering task (e.g. ray tracing). In such a case, this task which lies outside the capabilities of the data processing apparatus, can be allocated to the remote computing device, while the data processing apparatus may perform rendering tasks which lie within its capability.

It will be appreciated that the present disclosure is not particularly limited to the specific configuration of the data processing apparatus as described with reference to FIG. 3 of the present disclosure. In some examples, the functionality of the apparatus 3000 may be performed in a distributed manner using two or more respective processing devices. Moreover, the functionality of the apparatus 3000 may be performed by a number of discrete processing nodes (processing units). Hence more generally, the circuitry 1002 may in some cases be implemented in a distributed fashion using one or more (e.g. a plurality) of processing devices operable to communicate with each other via one or more wired and/or wireless networks.

Further details of embodiments of the disclosure will now be described.

### Rendering Tasks

As explained with reference to FIG. 3 of the present disclosure, the data processing apparatus 3000 includes a rendering processor 3002 which is configured to perform a first rendering task of a set of rendering tasks for rendering the one or more images. Furthermore, a second task of the set of rendering tasks is performed by a remote computing device. This means that different tasks of the set of rendering tasks which are to be performed are distributed between the data processing apparatus 3000 and the remote computing device.

A rendering task may form part of a set of rendering tasks which may be performed (a rendering pipeline). In examples, the set of rendering tasks may include some or all of the following (and potentially other steps not included here), in roughly, but not necessarily, the order given below.

### Camera Update

The position and/or orientation of the virtual camera within the environment may change, for example in response to movement of the player's character and either an automatic tracking camera (in the case of so-called third-person games) or motion and directional input (in the case of so-called first person games). Meanwhile some games have a fixed camera (e.g. 2D platform games) and so this update is skipped or a minimal process.

### Geometry Update

The geometry of the environment to be rendered may be updated if there are new elements to show, or if elements have changed. Similarly, changes in character animation/pose geometry may be defined/updated.

### Z-Buffer Update

What aspects of the environment are visible is updated depending on the geometry and the virtual camera viewpoint—parts that are unseen need not be processed, or only processed to a limited extent.

### Texturing

Texture maps are used to apply basic graphical imagery to the geometry of the scene. Typically different textures are used as a function of distance from the viewpoint.

### Static Lighting

Lightmaps may be used for direct and indirect lighting, shadows, and reflections.

### Dynamic Lighting

Direct and indirect lighting, shadows, and reflections may be computed for dynamic in-game light sources such as a player's torch.

### Atmospherics

Effects such as mist or fog, particle effects, translucency (water) and the like.

### Post Processing

A variety of effects that may be applied, often to the image as a whole, including bloom, exposure, depth of field bokeh, lens effects, and the like.

### Upscaling

If, in order to achieve a preferred frame rate, the rendering has been performed at a lower resolution than intended, some systems have a machine learning based AI upscaling step to in-paint the rendered image up to the target resolution. Optionally this step may be implemented at the client device, after receiving a lower resolution version of the image in the stream

More generally, in embodiments of the disclosure, the set of rendering tasks may include at least one of a base pass task, a static lighting task, a static shadows task, a reflections task, a post processing task, a dynamic lighting task, a dynamic shadows task, an atmospherics task, a translucency task, or a refraction task, a camera update task, a z-buffer update task, a texturing task or an upscaling task.

In practice some stages take longer than others or are more complex, and some may overlap or be revisited during the rendering process. Similarly, as noted above some stages may occur in a different order to that listed. However, in general the image is formed using successive stages. The amount of time (and processing resources) which a given task of the set of rendering tasks requires may vary depending on the type of virtual environment which is being rendered (e.g. depending on the complexity of the virtual environment, for example).

The decision as to which task (or tasks) to assign to the rendering processor of the data processing apparatus and which task (or tasks) to assign to the remote computing device is made by the allocation processor. In the present disclosure, the allocation processor is configured to allocate a task of the set of rendering tasks as either a first task (to be performed locally by the data processing apparatus) or remotely (by the remote computing device) can be made on a task by task basis; this allocation may dynamically change as required. The allocation processor may perform the allocation of tasks based on available processing resources of the data processing apparatus and an available communication bandwidth between the communication processor of the data processing apparatus and the remote computing device.

In examples, the processing resources of the data processing apparatus may include an absolute amount of processing resources of the data processing apparatus (e.g. a processing speed, an amount of processing memory, a type of CPU of the data processing apparatus, a type of GPU of the data processing apparatus, or the like). Different types of data processing apparatus may have different amounts of processing resources. For example, a user is playing a videogame on a first type of device (e.g. a portable computing device) then the amount of processing resources which are available may be less than if the user is playing a videogame on a second, different, type of device (e.g. an entertainment system). In examples, the processing resources of the data processing apparatus may also be defined as those resources which are currently available for use by the data processing apparatus during the rendering task. That is, a portion of the processing resources of the data processing apparatus may be occupied with a different processing task and may not necessarily be available for use during rendering. Therefore, the allocation processor may be configured to determine of the total amount of processing resources of the data processing apparatus, how many of those resources can actually be used for rendering. This determination may form the basis of the allocation of tasks between the data processing apparatus and the remote computing device.

In addition, the allocation processor is configured to perform the allocation on the basis of the bandwidth between the communication processor and the remote computing device. This may include, for example, a determination of the network speed (i.e. how quickly data can be transferred across the network between the data processing apparatus and the remote device). In examples, the allocation processor may perform a signal test to verify the available communication bandwidth between the communication processor and the remote computing device. In other examples, the allocation processor may receive information from a network management device concerning the availability of communication bandwidth between the communication processor and the remote computing device.

### Example System

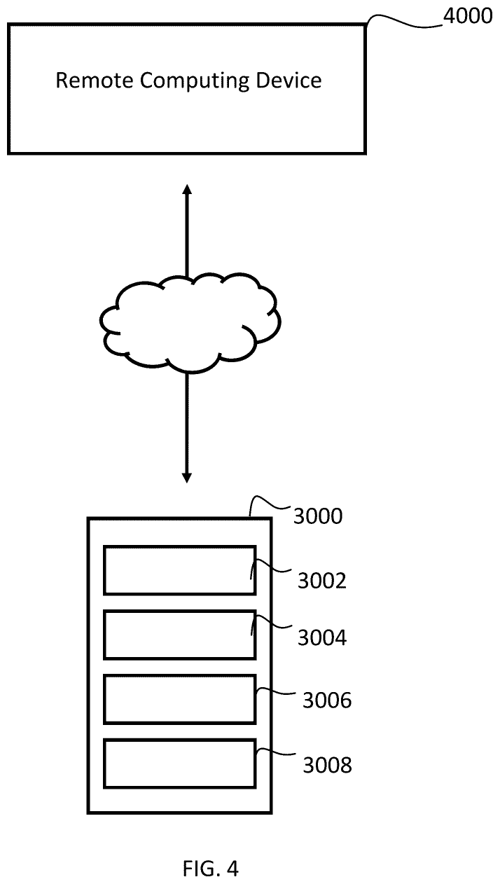

Consider, now, the example of FIG. 4 of the present disclosure. FIG. 4 illustrates an example system in accordance with embodiments of the disclosure.

The example system includes a remote computing device 4000 and a data processing apparatus 3000 (such as that described with reference to FIG. 3 of the present disclosure). The data processing apparatus and the remote computer device 4000 are connected to each other via a network (e.g. the internet).

In this example, a person is playing a videogame on the data processing apparatus 3000. The videogame is an example of a virtual environment. Furthermore, the data processing apparatus 3000 may be part of an entertainment system, for example, upon which the person is playing the videogame. Accordingly, the person provides certain input (e.g. using a controller) to control an action within the videogame. This input may be used, for example, to control the motion of a protagonist within the videogame. The game state may then be updated in response to the input.

The game state may also be updated in response to the action or actions of one or more other characters within the videogame (e.g. non-playable characters for example).

The person playing the videogame is able to perceive the current state of the videogame by viewing displayed images of that videogame (e.g. on a display device). These images are often generated (rendered) at a fixed schedule. The schedule may vary depending on the type of nature of the videogame being played, the videogame system upon which the user is playing the videogame (which affects, for example, the processing resources available for the videogame) and the settings which the user is using for playing the videogame (with, for example, a higher resolution sometimes requiring a lower frame rate). Indeed, rendering is generally understood as being a process of generating an image (e.g. a two-dimensional image) from data such as three-dimensional models (including, for example, the so-called game world—which includes the game environment and characters, objects and the like contained therein).

In this example, the frames of the videogame are rendered on a fixed schedule of 16 ms. That is, every 16 ms, a new frame is rendered from the three-dimensional models of the videogame, in order to produce an image which can then be displayed to the user. These frames therefore provide one or more images for display in a sequence.

The rendering tasks which are to be performed in order to render the frames of the videogame are allocated between the data processing apparatus 3000 and the remote computing device 4000. The remote computing device may be considered to have a much larger amount of processing resources at its disposable compared to the data processing apparatus 3000. For example, the data processing apparatus 3000 may be part of a server, or the like, which may have a very large number of GPUs compared to that which may be provided in a local data processing device. However, despite this, there may be a cost (in terms of latency) of transmitting data over the network between the data processing apparatus and the remote computing device. In other words, a complete allocation of all of the rendering tasks to the remote computing device would not produce the lowest latency in the rendering process. Likewise, rendering the entire videogame on the data processing apparatus 3000 may also not produce the lowest latency in the rendering process (e.g. if the data processing apparatus does not have sufficient processing resources at its disposable available for the rendering task).

Accordingly, in some examples, the data processing apparatus may prioritise the allocation of a task for rendering by the data processing apparatus, within a performance metric of the generation of the one or more images of the virtual environment. The performance metric may include, for example, a frame rate, or frame resolution, of the images which the data processing apparatus is able to generate of the videogame. Performing the rendering tasks locally on the data processing apparatus avoids the need to transfer the data over the network to the remote server (and thus removes one potential source of latency from the rendering process). However, if the available processing of the data processing apparatus is not sufficient in order to be able to perform the rendering tasks while meeting the performance metric, then an amount of the rendering task should then be allocated to the remote processing device, in order to avoid any increase in latency which may arise from an overloading of the processing resources of the data processing apparatus.

In examples, the allocation processor may be configured in order to determine the allocation of processing resources between the data processing apparatus and the remote computing device based on a prediction of the processing resources which will be required for the rendering task and/or a prediction of a communication bandwidth required to request data generated by rendering the one or more images from the remote computing device. The prediction can be used for comparison with the currently available processing resources and/or bandwidth in order to perform the allocation of the rendering tasks.

### Example Allocation

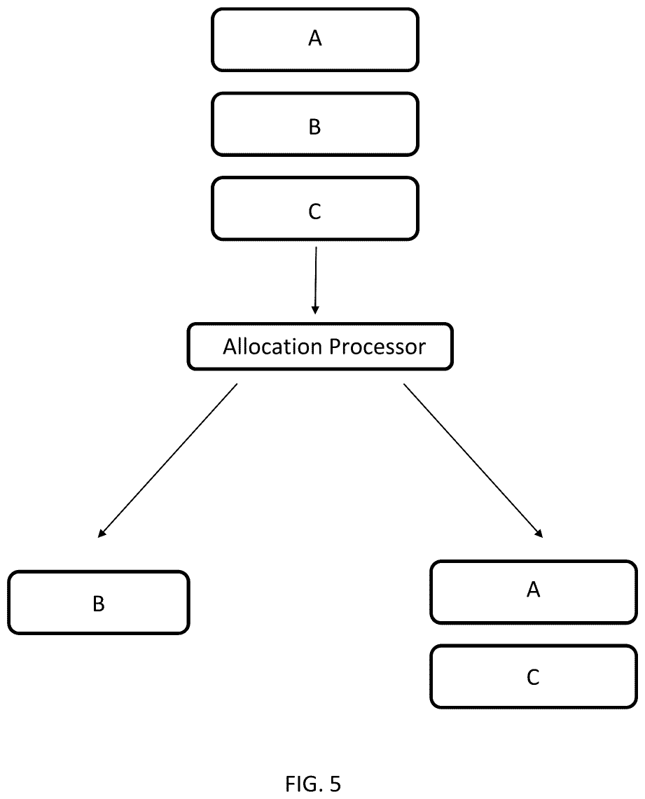

Consider, now, FIG. 5 of the present disclosure. FIG. 5 of the present disclosure illustrates an example of task allocation in accordance with embodiments of the disclosure.

In this example, a set of rendering tasks (A, B and C) are shown. These rendering tasks are assigned by the allocation processor to be performed by either the rendering processor of the data processing apparatus or for rendering by the remote computing device.

The rendering tasks A, B and C are not particularly limited in accordance with embodiments of the disclosure. Furthermore, it will be appreciated that a set of rendering tasks to be performed (that is, a rendering pipeline) may contain many more tasks than that shown in the example of FIG. 5. Nevertheless, the example of FIG. 5 can be used in order to illustrate a process which may be performed by the allocation processor in order to perform allocation of rendering tasks between the data processing apparatus and the remote computing device.

In this example, the task A may include a camera update task, task B may include a texturing task and task C may include a lighting task (e.g. static and/or dynamic lighting). These tasks, in this example, form the set of tasks which are to be performed in order to generate a frame (image) which can be displayed to the user such that the user can perceive the current state of the videogame.

At time of rendering, the allocation processor may determine which tasks should be performed by the rendering processor of the data processing apparatus and which tasks should be performed by the remote computing device.

In order to make this determination, the allocation may first determine the processing resources of the data processing apparatus which are currently available. For example, the allocation processor may determine the current processor utilization of the data processing apparatus, the current memory utilization of the data processing apparatus or the like. In this example, the allocation processor may determine that the processing resources of the data processing apparatus have an 80% utilization status.

Then, the allocation processor may also determine the available communication bandwidth between the communication processor of the data processing apparatus and the remote computing device. For example, the allocation processor may receive this information from a network manager and/or may perform a network test in order to determine this information. In this example, the allocation processor may determine that the currently available communication bandwidth is 500 Mbps.

Next, in this example, the allocation processor may perform a prediction of the amount of computing resources which are required in order to perform each of the rendering tasks A, B and C.

It will be appreciated that amount of time (and processing resources) which a given task of the set of rendering tasks requires may vary depending on the type of virtual environment which is being rendered (e.g. depending on the complexity of the virtual environment, for example). Therefore, the prediction of the amount of processing resources which a given task requires may include a prediction based on the type of rendering task which is to be performed and the type of virtual environment which is to be rendered. In examples, the prediction may also be based upon the processing resources which were required in order to perform that rendering task in a previous frame (e.g. historical performance data). In examples, the prediction may be performed by use of a trained model.

In examples, the trained model may include a machine learning model. However, before the machine learning model can be used in order to make this prediction, the machine learning model may be trained. Training of the machine learning model will now be described.

In examples, the machine learning model may be trained using either supervised or unsupervised learning.

Consider supervised learning. Here, the supervised learning model may be trained using labelled training data to learn a function that maps inputs (typically provided as feature vectors) to outputs (i.e. labels). Thus, the labelled training data includes pairs of inputs and corresponding output labels. The output labels are typically provided by an operator to indicate the desired output for each input. The supervised learning model processes the training data to produce an inferred function that can be used to map new (i.e. unseen) inputs to a label.

The input data (during training and/or inference) may include various types of data, such as numerical values, images, video, text, or audio. In the present disclosure, the input data may include information concerning the virtual environment to be rendered (e.g. the type of videogame, the content of the videogame or the like) and information concerning the rendering task to be performed (e.g. the type of rendering task, the parameters of the rendering task or the like). Raw input data may be pre-processed to obtain an appropriate feature vector used as input to the model—for example, features of an image or audio input may be extracted to obtain a corresponding feature vector. It will be appreciated that the type of input data and techniques for pre-processing of the data (if required) may be selected based on the specific task the supervised learning model is used for.

In the present disclosure, a labelled training data set may be obtained based on previous rendering task (e.g. as performed by the data processing apparatus in a previous situation).

Hence more generally, in some embodiments of the disclosure a machine learning model which is used to make the prediction may be a trained machine learning model which has been trained with training data including a virtual environment and rendering task as input and required computational resources as output. This represents one possible example of obtaining labelled training data from previous rendering of the virtual environment by the data processing apparatus.

Once prepared, the labelled training data set can be used to train the supervised learning model. During training the model adjusts its internal parameters (e.g. weights) so as to reduce (e.g. minimize) an error function, aiming to minimize the discrepancy between the model's predicted outputs and the labels provided as part of the training data. In the present disclosure, the label provided as part of the training data includes the required processing resources for performing a given rendering task on a given virtual environment. In some cases, the error function may include a regularization penalty to reduce overfitting of the model to the training data set.

The supervised learning model may use one or more machine learning algorithms in order to learn a mapping between its inputs and outputs. Example suitable learning algorithms include linear regression, logistic regression, artificial neural networks, decision trees, support vector machines (SVM), random forests, and the K-nearest neighbour algorithm.

Once trained, the supervised learning model may be used for inference—i.e. for predicting outputs (the required processing resources) for previously unseen input data (a given rendering task on a given virtual environment). The supervised learning model may perform classification and/or regression tasks. In a classification task, the supervised learning model predicts discrete class labels for input data, and/or assigns the input data into predetermined categories. In a regression task, the supervised learning model predicts labels that are continuous values.

In some cases, limited amounts of labelled data may be available for training of the model (e.g. because labelling of the data is expensive or impractical). In such cases, the supervised learning model may be extended to further use unlabelled data and/or to generate labelled data. Alternatively or in addition, training data for training the model may be obtained from rendering of other virtual environments that are similar to the current virtual environment. For example, training data may be obtained for a plurality of respective video game titles each corresponding to a same video game series for training the machine learning model. Similarly, training data may be obtained for a plurality of respective video game titles each corresponding to a same video game genre (e.g. a racing game genre, first person shooter genre and so on) for training the machine learning model.

Considering using unlabelled data, the training data may include both labelled and unlabelled training data, and semi-supervised learning may be used to learn a mapping between the model's inputs and outputs. For example, a graph-based method such as Laplacian regularization may be used to extend a SVM algorithm to Laplacian SVM in order to perform semi-supervised learning on the partially labelled training data.

Considering generating labelled data, an active learning model may be used in which the model actively queries an information source (such as a user, or operator) to label data points with the desired outputs. Labels are typically requested for only a subset of the training data set thus reducing the amount of labelling required as compared to fully supervised learning. The model may choose the examples for which labels are requested—for example, the model may request labels for data points that would most change the current model, or that would most reduce the model's generalization error. Semi-supervised learning algorithms may then be used to train the model based on the partially labelled data set.

As an aside, it is noted that unsupervised learning may be performed for training of the machine learning model. Unlike supervised learning, unsupervised machine learning uses unlabelled data and enables the machine learning model to find hidden patterns and data without any human intervention. The unsupervised learning may be performed in the same way as described for semi-supervised learning (e.g. for the part of the data for which labelled data is not provided) and will not be discussed in more detail at this stage.

Typically, the more data that the machine leaning model is trained upon, the more accurate the predictions of the machine learning model may become. In examples, the machine learning model may be trained on historical data. In examples, the machine learning model may be trained on simulated data. In examples, the model may be trained upon data from other data processing apparatuses.

Therefore, it will be appreciated that the machine learning model may be trained on training data such that it is able to predict, for previously unseen virtual environment and rendering task, the amount of processing resources which will be required in order to the rendering task.

While the process of training the machine learning model has been described with reference to a model which performs a prediction of the required computing resources, it will be appreciated that the present disclosure is not particularly limited in this regard. That is, the same process for training of the machine learning model may also be performed, with corresponding training data, for training the machine learning model to make a prediction of the communication bandwidth which would be required in order to request data generated by rendering the one or more images from the remote computing device.

Returning to the example of FIG. 5, it will be appreciated that the allocation process may thus make the prediction of the amount of processing resources which would be required to perform each rendering task and/or the amount of communication bandwidth which would be required in order to request data generated by rendering the one or more images from the remote computing device.

For example, the allocation processor may predict that task A would require 30% of the processing resources of the data processing apparatus, task B would require 15% of the processing resources of the data processing apparatus and task C would require 10% of the processing resources of the data processing apparatus. Furthermore, the allocation processor may determine that task A, B and C would each require at least 30% of the available communication bandwidth.

On this basis, the allocation processor may then determine which of the rendering tasks should be allocated to the data processing apparatus and which of the rendering tasks should be allocated to the remote computing device.

In this example, the allocation processor may, for example, identify that task A requires 30% of the processing resources of the data processing apparatus, which exceeds the 20% of the processing resources which are currently available. Therefore, the allocation processor may determine that the use of the rendering processor of the data processing apparatus for performing the rendering task A would lead to an increase in the latency in performing the rendering (since the required processing resources, to perform this rendering task, are not currently available to the data processing apparatus). Furthermore, the allocation processor may identify that the currently available bandwidth is sufficient for that task to be performed by the remote computing device (since task A would require only 10% of the available communication bandwidth for transmission and reception over the network to the remote computing device). As such, the allocation processor may allocate task A to the remote computing device.

However, the allocation processor may, for example, identify that task B requires only 15% of the processing resources of the data processing apparatus, which is less than the 20% of the processing resources of the data processing apparatus which are currently available. As such, the allocation processor may determine that task B can be performed by the data processing apparatus without increasing the latency of rendering. As such, the allocation processor may allocate the task B to be performed by the rendering processor of the data processing apparatus.

Finally, the allocation processor may identify that task C requires only 10% of the processing resources of the data processing apparatus, which is less than the 20% of the processing resources which are currently available. However, the allocation processor may identify that task B has already been allocated to the rendering processor of the data processing apparatus. Since task B requires 15% of the processing resources of the data processing apparatus, only 5% of the processing resources which are currently available remain unallocated (i.e. the 20% which are currently available minus the 15% which have already been allocated (to the processing of task B)). Therefore, the allocation processor may identify that task C cannot also be allocated to the data processing apparatus (alongside task B) without increasing the latency of rendering. Accordingly, the allocation processor may compare the necessary bandwidth for completion of task C by the remote computing device with the currently available bandwidth and determine that task C should also be allocated to the remote computing device.

In this way, the allocation processor can allocate the different rendering tasks between the data processing apparatus and the remote computing device, in order to most efficiently perform the allocation of rendering tasks and ensure low latency rendering of the virtual environment.

In examples, once the tasks have been allocated, those tasks may be performed in sequence by the data processing apparatus and the remote computing device. That is, in some examples, each rendering task may depend on the rendering which has been performed in the preceding task.

However, in other examples, the different rendering tasks (or a number of those rendering tasks) may be performed in parallel (e.g. where the result of one of the rendering tasks is not dependent upon the result of a preceding rendering task). In examples, even when the rendering tasks should be performed in sequence, the rendering tasks may nevertheless be performed in parallel for different parts of the one or more images.

In some examples, an image of the virtual environment to be rendered may be split into different portions, or regions (such as a tile). The same rendering pipeline should be applied across the different portions, or regions. However, by splitting the image of the virtual environment to be rendered into these different portions, it becomes possible to parallelise the rendering pipeline. That is, the rendering tasks to be performed can be performed on the different tiles in parallel. In examples, one or more different remote devices may be configured to perform the rendering for each of the different portions.

Accordingly, in examples, the data processing apparatus may be further configured to partition the one or more images of the virtual environment to be rendered into a plurality of different potions, and the allocation processor may be configured to allocate the second rendering task for different portions to different remote devices.

However, for some rendering tasks, the rendering task may be dependent upon an earlier task of the rendering pipeline. For example, lighting calculations may be dependent upon a geometry pass of the entire scene (to obtain normal/depth information (e.g. a G-BUFFER)).

In examples, instead of having a dependency of first rendering the G-BUFFER, which may unnecessarily delay the parallelisation of the different regions for the processing of the lighting task, each remote device may be configured to perform some redundant work in order to further increase parallelism. For example, each remote device may, individually and independently perform rendering of the G-BUFFER for the entire scene, before proceeding to perform a subsequent rendering task (e.g. lighting calculations) for a given portion of the scene (such that the lighting calculations can be performed, by the different remote devices, in parallel for the different portions of the scene).

The allocation processor may be configured to perform certain processing in order to determine when it would be more efficient to perform tasks in sequence and synchronize the results and when it would be more efficient to, redundantly, perform some additional work (such that a later stage of the rendering pipeline can be parallelised). For example, it may be determined that a computationally inexpensive task (e.g. G-BUFFER) can be performed with redundancy across the different remote computational devices, while an expensive task (e.g. complex lighting calculations) should not be performed with redundancy. In examples, a trained model (such as a machine learning model) may be trained to perform the allocation in this manner (being trained in the manner which has already been described earlier in the disclosure).

Therefore, in examples, when the second rendering task is dependent upon a preceding rendering task, the allocation processor may be configured to determine whether to centrally perform the preceding rendering task or whether to perform the preceding rendering task individually on each of the different remote devices.

Of course, the example of FIG. 5 is merely one such example of how the allocation of rendering tasks can be performed in accordance with embodiments of the disclosure. The present disclosure is not particularly limited to this example.

The example of FIG. 5 provides an example of the use of heuristics for determining whether or not the task should be allocated to the data processing apparatus or the remote computing device. That is, the allocation processor may be configured to use a number of different rules for determining the allocation of the different tasks (e.g. does the predicted processing resource exceed the currently available processing resource, prioritise allocation to the data processing apparatus and the like). However, in examples, the allocation between the data processing apparatus and the remote computing device can also be performed by the use of a trained model (e.g. a machine learning model, or the like). The trained model may be trained in a supervised or unsupervised manner as has already been described. The trained model may then take certain information as input (e.g. type of rendering task, virtual environment and currently available processing resources and communication bandwidth) and provide certain information as output (e.g. allocation of a task to the data processing apparatus or the remote computing device) with an aim to provide an efficient allocation of the rendering tasks between the remote computing device and the data processing apparatus, which can achieve low latency rendering.

In examples, the allocation may be made, by the allocation processor, based on a comparison of the latency cost to performing the rendering on either of the rendering processor of the data processing apparatus or the remote computing device. That is, it may be determined that neither the data processing apparatus nor the remote computing device are optimally positioned in order to perform the rendering task. However, in this situation, the allocation processor may allocate the task to the data processing apparatus or the remote computing device depending on which of these allocations would increase the rendering latency by the lowest amount.

In examples, the allocation of tasks between the remote computing device and the data processing apparatus may be based on a prediction of the computational cost of a given task (e.g. of shading) and/or based on a prediction of the bitrate needed to stream data from the cloud to the client (e.g. of streaming the G-buffer to the client, instead of the buffer being computed on the client). In examples, the machine learning model may then compare these predictions to the computing resources available on the data processing apparatus and to the available bandwidth between the remote computing device and the data processing apparatus. The machine learning model can then determine whether a given rendering task (e.g. lighting operations) should be performed on the cloud with results streamed to the client, or performed directly on the client. In examples, the aim of the machine learning model may be to shift as much of the rendering as possible to the data processing apparatus to minimise latency associated with transmission of data from the remote computing apparatus; with the caveat that the data processing apparatus is not overloaded with excessive processing load.

In examples, the allocation processor may identify that neither the data processing apparatus nor the remote computing device can perform the rendering task while still satisfying a certain performance metric (e.g. a certain frame rate). Accordingly, in some examples, based on this information, the allocation processor may further be configured to temporarily disregard a task (e.g. upscaling) from the set of rendering tasks when both the available processing resources and available communication bandwidth are below a threshold value (the threshold value being, for example, the necessary resources or communication bandwidth for performing the task with low latency). This ensures that an image can still be rendered for display to the user with low latency, even if that image is not optimally rendered. In examples, the allocation processor may be configured to perform adaptation of one or more rendering tasks in response to the determination that neither the data processing apparatus nor the remote computing device can perform the rendering task while still satisfying the performance metric. For example, the allocation processor may adapt one or more tasks of the set of tasks to reduce the overall resources or communication bandwidth required for the rendering tasks (that is, the rendering pipeline). As an example, the allocation processor may be configured to adapt one or more of the complexity, resolution or framerate of the rendering which is to be performed.

In examples, the allocation processor may be configured to detect a change in at least one of the available processing resources and/or the available communication bandwidth and perform re-allocation of a task of the set of rendering tasks as the first or second rendering task on the basis of the change. For example, the allocation processor may detect a deterioration in the network condition (e.g. communication bandwidth) between the data processing apparatus and the remote computing device, and may therefore change the allocation of tasks between the data processing apparatus and the remote computing device on this basis, in order to ensure that an efficient allocation of tasks—leading to lower latency rendering—can still be achieved. In examples, the allocation of tasks between the data processing apparatus and the remote computing device may change on a frame by frame basis (i.e. for each image which is to be rendered of the virtual environment). This may arise because of a change in conditions and/or a change in the prediction of the amount of resources/communication bandwidth which would be required in order to perform a certain rendering task for a given frame.

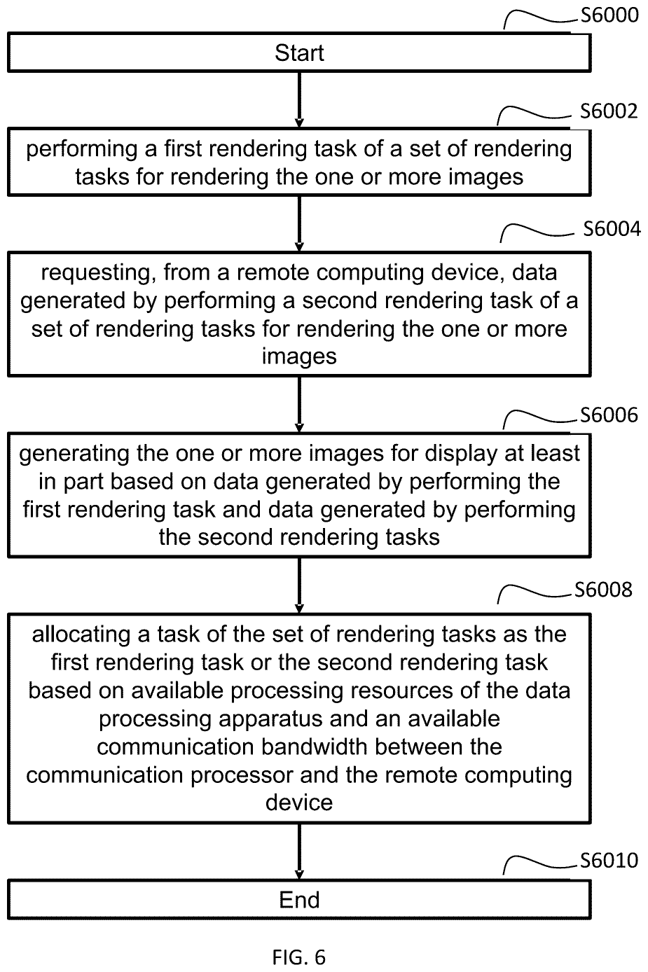

Consider, now, the example of FIG. 6 of the present disclosure. FIG. 6 illustrates an example method for generating one or more images of a virtual environment in accordance with embodiments of the disclosure.

In examples, the method of FIG. 6 may be performed on a data processing apparatus such as that described with reference to FIG. 3 of the present disclosure, for example. However, the present disclosure is not particularly limited in this respect and any suitable processing device may be configured to perform the method of FIG. 6 of the present disclosure are required.

The example method of FIG. 6 starts at step S6000 and proceeds to step S6002.

In step S6002, the method includes performing a first rendering task of a set of rendering tasks for rendering the one or more images.

In step S6004, the method includes requesting, from a remote computing device, data generated by performing a second rendering task of a set of rendering tasks for rendering the one or more images.

In step S6006, the method includes generating the one or more images for display at least in part based on data generated by performing the first rendering task and data generated by performing the second rendering task.

In step S6008, the method includes allocating a task of the set of rendering tasks as the first rendering task or the second rendering task based on available processing resources of the data processing apparatus and an available communication bandwidth between the communication processor and the remote computing device.

In this example, the method proceeds to, and ends with, step S6010.

It will be appreciated that the embodiments of the present disclosure are not particularly limited to the example method illustrated in FIG. 6. For example, a number of method steps described with reference to FIG. 6 of the present disclosure may be performed in a different order than that illustrated with reference to FIG. 6. Furthermore, a number of additional method steps may also be included compared to the method steps illustrated in FIG. 6 of the present disclosure.

As an example, the method step S6002 and the method step S6004 as illustrated in FIG. 6 may be performed in a different order than that shown (e.g. with step S6004 being performed before step S6002). Alternatively, the method step S6002 and the method step S6004 may, in some examples, be performed at the same time (that is, these steps may be performed, optionally, in parallel with each other).

As such, while FIG. 6 illustrates one example method of the present disclosure, it will be appreciated that the present disclosure is not particularly limited in this regard.

Furthermore, it will be appreciated that the methods of the present disclosure may be carried out on conventional hardware (such as that described previously herein) suitably adapted as applicable by software instruction or by the inclusion or substitution of dedicated hardware. Thus, the required adaptation to existing parts of a conventional equivalent device may be implemented in the form of a computer program product comprising processor implementable instructions stored on a non-transitory machine-readable medium such as a floppy disk, optical disk, hard disk, PROM, RAM, flash memory or any combination of these or other storage media, or realized in hardware as an ASIC (application specific integrated circuit) or an FPGA (field programmable gate array) or other configurable circuit suitable to use in adapting the conventional equivalent device. Separately, such a computer program may be transmitted via data signals on a network such as an Ethernet, a wireless network, the Internet, or any combination of these or other networks.

Furthermore, embodiments of the present disclosure can be arranged in accordance with the following numbered clauses:
1) A data processing apparatus for generating one or more images of a virtual environment, the apparatus comprising:
   a rendering processor configured to perform a first rendering task of a set of rendering tasks for rendering the one or more images;
   a communication processor configured to request, from a remote computing device, data generated by performing a second rendering task of a set of rendering tasks for rendering the one or more images;
   an output image processor configured to generate the one or more images for display at least in part based data generated by performing the first rendering task and data generated by performing the second rendering task; and
   an allocation processor configured to allocate a task of the set of rendering tasks as the first rendering task or the second rendering task based on available processing resources of the data processing apparatus and an available communication bandwidth between the communication processor and the remote computing device.
2) The data processing apparatus according to clause 1, wherein the allocation processor is further configured to predict processing resources required for rendering the one or more images and allocate a task of the set of rendering tasks as the first rendering task or the second rendering task based on a comparison of the processing resources required for rendering and the available processing resources of the data processing apparatus.
3) The data processing apparatus according to clause 1 or 2, wherein the allocation processor is further configured to predict a communication bandwidth required to request data generated by rendering the one or more images from the remote computing device and allocate a task of the set of rendering tasks as the first rendering task or the second rendering task based on a comparison of the predicted communication bandwidth and the available communication bandwidth between the communication processor and the remote computing device.
4) The data processing apparatus according to any preceding clause, wherein the allocation processor is configured to use a machine learning model for allocation of a task of the set of rendering tasks as the first rendering task or the second rendering task.
5) The data processing apparatus according to any preceding clause, wherein the allocation processor is configured to apply one or more heuristics for allocation of the task of the set of rendering tasks as the first rendering task or the second rendering task.
6) The data processing apparatus according to any preceding clause, wherein the set of rendering tasks includes at least one of a base pass task, a static lighting task, a static shadows task, a reflections task, a post processing task, a dynamic lighting task, a dynamic shadows task, an atmospherics task, a translucency task, or a refraction task.
7) The data processing apparatus according to any preceding clause, wherein the allocation processor is configured to prioritise allocation of a task of the set of rendering tasks as the first rendering task within a performance metric of the generation of the one or more images of the virtual environment.
8) The data processing apparatus according to clause 7, wherein the performance metric includes at least one of a frame rate and/or a frame resolution.
9) The data processing apparatus according to any preceding clause, wherein the allocation processor is configured to detect a change in at least one of the available processing resources and/or the available communication bandwidth and perform re-allocation of a task of the set of rendering tasks as the first or second rendering task on the basis of the change.
10) The data processing apparatus according to any preceding clause, wherein the allocation processor is further configured to temporarily disregard a task from the set of rendering tasks when both the available processing resources and available communication bandwidth are below a threshold value,
11) The data processing apparatus according to any preceding clause, wherein the one or more images comprise a plurality of images for display in a sequence.
12) The data processing apparatus according to any preceding clause, wherein the data processing apparatus comprises an electrical storage device, and wherein the allocation processor is further configured to allocate a task of the set of rendering tasks as the first rendering task or the second rendering task at least in part based on one or more of: a status of the electrical storage device or an electrical cost of the task to be allocated.
13) The data processing apparatus according to any preceding clause, wherein the allocation processor is further configured to allocate a task of the set of rendering tasks as the first rendering task or the second rendering task in accordance with a rendering capability of the rendering processor of the data processing apparatus.
14) The data processing apparatus, according to any preceding clause, wherein the data processing apparatus is further configured to partition the one or more images of the virtual environment to be rendered into a plurality of different potions, and wherein the allocation processor is configured to allocate the second rendering task for different portions to different remote devices.
15) The data processing apparatus according to any preceding clause, wherein when the second rendering task is dependent upon a preceding rendering task, the allocation processor is configured to determine whether to centrally perform the preceding rendering task or whether to perform the preceding rendering task individually on each of the different remote devices.
16) A data processing system for generating one or more images of a virtual environment, the data processing system comprising the data processing apparatus according to any preceding clause and the remote computing device.
17) A data processing method for generating one or more images of a virtual environment, the method comprising:
   performing a first rendering task of a set of rendering tasks for rendering the one or more images;
   requesting, from a remote computing device, data generated by performing a second rendering task of a set of rendering tasks for rendering the one or more images;
   generating the one or more images for display at least in part based on data generated by performing the first rendering task and data generated by performing the second rendering task; and
   allocating a task of the set of rendering tasks as the first rendering task or the second rendering task based on available processing resources of the data processing apparatus and an available communication bandwidth between the communication processor and the remote computing device.
18) A computer program comprising instructions which, when implemented by a computer, cause the computer to perform a method according to clause 17.
19) A non-transient computer readable storage medium configured to store the computer program according to clause 18.

In accordance with embodiments of the disclosure, communication between users within a multiplayer gaming environment can be performed more quickly and easily.

Furthermore, it will be appreciated that numerous modifications and variations of the present disclosure are possible in light of the above teachings. It is therefore to be understood that within the scope of the appended claims, the disclosure may be practiced otherwise than as specifically described herein.

In so far as embodiments of the disclosure have been described as being implemented, at least in part, by software-controlled data processing apparatus, it will be appreciated that a non-transitory machine-readable medium carrying such software, such as an optical disk, a magnetic disk, semiconductor memory or the like, is also considered to represent an embodiment of the present disclosure.

It will be appreciated that the above description for clarity has described embodiments with reference to different functional units, circuitry and/or processors. However, it will be apparent that any suitable distribution of functionality between different functional units, circuitry and/or processors may be used without detracting from the embodiments.

Described embodiments may be implemented in any suitable form including hardware, software, firmware or any combination of these. Described embodiments may optionally be implemented at least partly as computer software running on one or more data processors and/or digital signal processors. The elements and components of any embodiment may be physically, functionally and logically implemented in any suitable way. Indeed the functionality may be implemented in a single unit, in a plurality of units or as part of other functional units. As such, the disclosed embodiments may be implemented in a single unit or may be physically and functionally distributed between different units, circuitry and/or processors.

Although the present disclosure has been described in connection with some embodiments, it is not intended to be limited to the specific form set forth herein. Additionally, although a feature may appear to be described in connection with particular embodiments, one skilled in the art would recognize that various features of the described embodiments may be combined in any manner suitable to implement the technique.

What is claimed is:

1. A data processing apparatus for generating one or more images of a virtual environment, the apparatus comprising:
a rendering processor configured to perform a first rendering task of a set of rendering tasks for rendering the one or more images;
a communication processor configured to request, from a remote computing device, data generated by performing a second rendering task of a set of rendering tasks for rendering the one or more images;
an output image processor configured to generate the one or more images for display at least in part based on data generated by performing the first rendering task and data generated by performing the second rendering task; and
an allocation processor configured to allocate a task of the set of rendering tasks as the first rendering task or the second rendering task based on available processing resources of the data processing apparatus and an available communication bandwidth between the communication processor and the remote computing device.

2. The data processing apparatus of claim 1, wherein the allocation processor is further configured to predict processing resources required for rendering of the one or more images and allocate a task of the set of rendering tasks as the first rendering task or the second rendering task based on a comparison of the processing resources required for rendering and the available processing resources of the data processing apparatus.

3. The data processing apparatus of claim 1, wherein the allocation processor is further configured to predict a communication bandwidth required to request data generated by rendering the one or more images from the remote computing device and allocate a task of the set of rendering tasks as the first rendering task or the second rendering task based on a comparison of the predicted communication bandwidth and the available communication bandwidth between the communication processor and the remote computing device.

4. The data processing apparatus of claim 1, wherein the allocation processor is configured to use a machine learning model for allocation of a task of the set of rendering tasks as the first rendering task or the second rendering task.

5. The data processing apparatus of claim 1, wherein the allocation processor is configured to apply one or more heuristics for allocation of the task of the set of rendering tasks as the first rendering task or the second rendering task.

6. The data processing apparatus of claim 1, wherein the set of rendering tasks includes at least one of: a base pass task, a static lighting task, a static shadows task, a reflections task, a post processing task, a dynamic lighting task, a dynamic shadows task, an atmospherics task, a translucency task, or a refraction task, a camera update task, a z-buffer update task, a texturing task or an upscaling task.

7. The data processing apparatus of claim 1, wherein the allocation processor is configured to prioritise allocation of a task of the set of rendering tasks as the first rendering task within a performance metric of the generation of the one or more images of the virtual environment.

8. The data processing apparatus of claim 7, wherein the performance metric includes at least one of: a frame rate and/or a frame resolution.

9. The data processing apparatus of claim 1, wherein the allocation processor is configured to detect a change in at least one of the available processing resources and/or the available communication bandwidth and perform re-allocation of a task of the set of rendering tasks as the first or second rendering task on the basis of the change.

10. The data processing apparatus of claim 1, wherein the allocation processor is further configured to temporarily disregard a task from the set of rendering tasks when both the available processing resources and available communication bandwidth are below a threshold value.

11. The data processing apparatus of claim 1, wherein the one or more images comprise a plurality of images for display in a sequence.

12. The data processing apparatus of claim 1, wherein the data processing apparatus comprises an electrical storage device, and wherein the allocation processor is further configured to allocate a task of the set of rendering tasks as the first rendering task or the second rendering task at least in part based on one or more of: a status of the electrical storage device or an electrical cost of the task to be allocated.

13. The data processing apparatus of claim 1, wherein the allocation processor is further configured to allocate a task of the set of rendering tasks as the first rendering task or the second rendering task in accordance with a rendering capability of the rendering processor of the data processing apparatus.

14. The data processing apparatus of claim 1, wherein the data processing apparatus is further configured to partition the one or more images of the virtual environment to be rendered into a plurality of different potions, and wherein the allocation processor is configured to allocate the second rendering task for different portions to different remote devices.

15. The data processing apparatus of claim 1, wherein when the second rendering task is dependent upon a preceding rendering task, the allocation processor is configured to determine whether to centrally perform the preceding rendering task or whether to perform the preceding rendering task individually on each of the different remote devices.

16. A data processing system for generating one or more images of a virtual environment, the data processing system, the system comprising:
a remote computing device; and
a data processing apparatus for generating one or more images of a virtual environment, the apparatus comprising:
a rendering processor configured to perform a first rendering task of a set of rendering tasks for rendering the one or more images;
a communication processor configured to request, from a remote computing device, data generated by performing a second rendering task of a set of rendering tasks for rendering the one or more images;
an output image processor configured to generate the one or more images for display at least in part based on data generated by performing the first rendering task and data generated by performing the second rendering task; and
an allocation processor configured to allocate a task of the set of rendering tasks as the first rendering task or the second rendering task based on available processing resources of the data processing apparatus and an available communication bandwidth between the communication processor and the remote computing device.

17. The data processing system of claim 16, wherein the allocation processor is further configured to predict processing resources required for rendering of the one or more images and allocate a task of the set of rendering tasks as the first rendering task or the second rendering task based on a comparison of the processing resources required for rendering and the available processing resources of the data processing apparatus.

18. The data processing system of claim 16, wherein the allocation processor is further configured to predict a communication bandwidth required to request data generated by rendering the one or more images from the remote computing device and allocate a task of the set of rendering tasks as the first rendering task or the second rendering task based on a comparison of the predicted communication bandwidth and the available communication bandwidth between the communication processor and the remote computing device.

19. A data processing method for generating one or more images of a virtual environment, the method comprising:
performing a first rendering task of a set of rendering tasks for rendering the one or more images;
requesting, from a remote computing device, data generated by performing a second rendering task of a set of rendering tasks for rendering the one or more images;
generating the one or more images for display at least in part based on data generated by performing the first rendering task and data generated by performing the second rendering task; and
allocating a task of the set of rendering tasks as the first rendering task or the second rendering task based on available processing resources of the data processing apparatus and an available communication bandwidth between the communication processor and the remote computing device.

20. The data processing method of claim 19, further comprising:
predicting processing resources required for rendering of the one or more images and allocate a task of the set of rendering tasks as the first rendering task or the second rendering task based on a comparison of the processing resources required for rendering and the available processing resources of the data processing apparatus.
